(19) United States
(12) Patent Application Publication
(10) Pub. No.: US 2026/0084720 A1
(43) Pub. Date: Mar. 26, 2026

(54) Vehicle and Method of Controlling the Same

(71) Applicants: Hyundai Motor Company, Seoul (KR); Kia Corporation, Seoul (KR)

(72) Inventors: Jun Young Park, Hwaseong-Si, (KR); Su Rim Kwon, Hwaseong-Si (KR)

(21) Appl. No.: 19/225,750

(22) Filed: Jun. 2, 2025

(30) Foreign Application Priority Data
Sep. 20, 2024 (KR) 10-2024-0127301

(51) Int. Cl. B60W 60/00; B60W 30/09; B60W 30/095; B60W 30/18; B60W 50/00

(52) U.S. Cl. CPC B60W 60/0017; B60W 30/09; B60W 30/0956; B60W 30/18154; B60W 30/18159; B60W 50/0097; B60W 2552/53; B60W 2554/4029; B60W 2554/4041; B60W 2554/4045; B60W 2554/801; B60W 2554/802; B60W 2555/60; B60W 2556/20; B60W 2556/40

(57) ABSTRACT

According to the present disclosure, there is provided a vehicle including one or more sensors configured to detect a pedestrian in an exterior environment of the vehicle, one or more processors, and memory. The vehicle may execute: a first process configured to determine, based on map information and traffic signal information, intersection information regarding an intersection associated with the vehicle; a second process configured to: receive, from the one or more sensors, pedestrian information regarding the pedestrian; and determine, based on the pedestrian information indicating a position of the pedestrian, a pedestrian type of the pedestrian; a third process configured to determine, based on the pedestrian type of the pedestrian and further based on vehicle movement information of the vehicle, a pedestrian danger level; and a fourth process configured to control, based on the pedestrian danger level, an autonomous driving operation of the vehicle.

### CROSS-REFERENCE TO RELATED APPLICATION

This application claims priority to and the benefit of Korean Patent Application No. 10-2024-0127301, filed on Sep. 20, 2024, the disclosure of which is incorporated herein by reference in its entirety.

### BACKGROUND

### Field

The present disclosure relates to a vehicle and a method of controlling the same.

### INTRODUCTION

Autonomous vehicles should establish real-time response strategies for a large number of pedestrians on general roads, intersections, and crosswalks while traveling in urban areas. However, when an autonomous vehicle cannot accurately determine whether a response to a detected pedestrian is required, dangerous situations such as collisions can occur. Alternatively, an unnecessary deceleration or stopping situation of the host vehicle can occur.

Since conventional autonomous vehicles generate predicted paths of pedestrians based on their positions and speeds, and establish response strategies for pedestrians, the host vehicle is often controlled according to an unnecessary deceleration or stopping response strategy in response to pedestrians who do not intend to cross the road.

### SUMMARY

The present disclosure is directed to providing a vehicle and a method of controlling the same which are capable of determining a pedestrian's intention to classify a pedestrian danger level and establishing customized a control strategy for a host vehicle accordingly.

According to one or more example embodiments of the present disclosure, a vehicle may include: one or more sensors configured to detect a pedestrian in an exterior environment of the vehicle; one or more processors; and a memory. The memory may store at least one instruction that is configured, when executed by the one or more processors communicating with the memory, to cause the vehicle to execute: a first process configured to determine, based on map information and traffic signal information, intersection information regarding an intersection associated with the vehicle; a second process configured to: receive, from the one or more sensors, pedestrian information regarding the pedestrian; and determine, based on the pedestrian information indicating a position of the pedestrian, a pedestrian type of the pedestrian; a third process configured to determine, based on the pedestrian type of the pedestrian and further based on vehicle movement information of the vehicle, a pedestrian danger level; and a fourth process configured to control, based on the pedestrian danger level, an autonomous driving operation of the vehicle.

The first process may be configured to determine the intersection information by: determining, based on the map information, the intersection; and determining, based on the vehicle movement information, a remaining distance and a remaining time to a stop line associated with a crosswalk in the intersection.

The first process may be further configured to: determine, based on a route of the vehicle passes through the intersection having a traffic light, a current state and a state change time of the traffic light.

The second process may be configured to determine the pedestrian type based on an attribute of an area in which the pedestrian is positioned.

The third process may be configured to determine the pedestrian danger level by: determining, based on the pedestrian type, a predicted path of the pedestrian.

The third process may be configured to determine the pedestrian danger level further by: determining, based on the vehicle movement information, a likelihood value of convergence of the predicted path of the pedestrian and a route of the vehicle.

The third process may be configured to determine the pedestrian danger level further by: determining, based on the likelihood value of the convergence being above a threshold and using the vehicle movement information and the predicted path of the pedestrian, a predicted location of the convergence, a predicted time of the convergence, a longitudinal distance between the route and the pedestrian, and a lateral distance between the route and the pedestrian.

The third process may be configured to determine the pedestrian danger level further by: determining, based on the likelihood value of the convergence being below a threshold and using the vehicle movement information and the predicted path of the pedestrian to determine the pedestrian danger level: a longitudinal distance between the route and the pedestrian, and a lateral distance between the route and the pedestrian.

The at least one instruction may be configured, when executed by the one or more processors communicating with the memory, to cause the vehicle to execute a fifth process configured to determine, based on the pedestrian danger level, a response control strategy for the vehicle. The response control strategy may include at least one of a stop response control or a deceleration response control.

The fourth process may be configured to control the autonomous driving operation of the vehicle by: determining a reliability value associated with the pedestrian based on whether a previous response control strategy for the pedestrian is output; and determining, based on the pedestrian danger level and the reliability value associated with the pedestrian, whether a response control of the vehicle is needed.

The fourth process may be configured to determine, based on the pedestrian information, whether a second pedestrian is present along a route of the vehicle and a predicted path of the pedestrian; and determine, based on whether the second pedestrian is present, whether a response control of the vehicle is needed.

According to one or more example embodiments of the present disclosure, a method performed by an apparatus of a vehicle may include: determining, based on map information and traffic signal information, intersection information regarding an intersection associated with the vehicle; receiving, from one or more sensors of the vehicle, pedestrian information regarding a pedestrian present in an exterior environment of the vehicle; determining, based on the pedestrian information indicating a position of the pedestrian, a pedestrian type of the pedestrian; determining, based on the pedestrian type of the pedestrian and further based on vehicle movement information of the vehicle, a pedestrian danger level; and controlling, based on the pedestrian danger level, an autonomous driving operation of the vehicle.

Determining the intersection information may include: determining, based on the map information, the intersection; and determining, based on the vehicle movement information, a remaining distance and a remaining time to a stop line associated with a crosswalk in the intersection.

The method may further include: determining, based on a route of the vehicle passes through the intersection having a traffic light, a current state and a state change time of the traffic light.

Determining the pedestrian type may include determining the pedestrian type based on an attribute of an area in which the pedestrian is positioned.

Determining the pedestrian danger level may include: determining, based on the pedestrian type, a predicted path of the pedestrian; and determining, based on the vehicle movement information, a likelihood value of convergence of the predicted path of the pedestrian and a route of the vehicle.

Determining the pedestrian danger level further may include: determining, based on the likelihood value of the convergence being above a threshold and using the vehicle movement information and the predicted path of the pedestrian to determine the pedestrian danger level, a predicted location of the convergence, a predicted time of the convergence, a longitudinal distance between the route and the pedestrian, and a lateral distance between the route and the pedestrian; and determining the pedestrian danger level based on the predicted location of the convergence, the predicted time of the convergence, the longitudinal distance and the lateral distance.

Determining the pedestrian danger level may further include: determining, based on the likelihood value of the convergence being below a threshold and using the vehicle movement information and the predicted path of the pedestrian to determine the pedestrian danger level: a longitudinal distance between the route and the pedestrian, and a lateral distance between the route and the pedestrian; and determining the pedestrian danger level based on the longitudinal distance and the lateral distance.

The method may further include: determining, based on the pedestrian danger level, a response control strategy for the vehicle. The response control strategy may include at least one of a stop response control or a deceleration response control.

Controlling the autonomous driving operation of the vehicle may include: determining a reliability value associated with the pedestrian based on whether a previous response control strategy for the pedestrian is output; determining whether a second pedestrian is present along a route of the vehicle and a predicted path of the pedestrian; and determining, based on whether the second pedestrian is present and based on the reliability value, whether a response control of the vehicle is needed.

### BRIEF DESCRIPTION OF THE DRAWINGS

The above and other objects, features and advantages of the present disclosure will become more apparent to those of ordinary skill in the art by describing one or more example embodiments thereof in detail with reference to the accompanying drawings, in which:

FIG. 1 is a view showing an example vehicle communicating with other devices to transmit and receive data;

FIG. 2 is a view showing example components of a vehicle;

FIG. 3 is a view for describing an example operation of a processor;

FIGS. 4 and 5 are conceptual diagrams for describing example response control strategies of a vehicle; and

FIGS. 6, 7, 8, 9, and 10 are flowcharts of one or more example methods of controlling a vehicle.

### DETAILED DESCRIPTION

Hereinafter, one or more example embodiments according to the present disclosure will be described in detail with reference to the accompanying drawings.

However, the technical spirit of the present disclosure is not limited to some of the described example embodiments, but may be implemented in various different forms, and one or more of the components among the example embodiments may be used by being selectively coupled or substituted without departing from the scope of the technical spirit of the present disclosure.

In addition, terms (including technical and scientific terms) used in one or more example embodiments of the present disclosure may be construed as meaning that may be generally understood by those skilled in the art to which the present disclosure pertains unless explicitly specifically defined and described, and the meanings of the commonly used terms, such as terms defined in a dictionary, may be construed in consideration of contextual meanings of related technologies.

In addition, the terms used in the one or more example embodiments of the present disclosure are for describing the example embodiments and are not intended to limit the present disclosure.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., assessing a pedestrian danger level) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., assessing a pedestrian danger level) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., assessing a pedestrian danger level) described herein.

Minimum risk maneuver (MRM) operation(s) may also be controlled, for example, based on one or more features (e.g., assessing a pedestrian danger level) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., assessing a pedestrian danger level) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may include an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., assessing a pedestrian danger level) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

The vehicle that an autonomous driving system is actively controlling may be referred to as an ego vehicle, a host vehicle, or an autonomous vehicle. The ego vehicle (e.g., the host vehicle, the autonomous vehicle, etc.) may be the vehicle that is equipped with the autonomous driving system. A car that is ahead of the ego vehicle (e.g., in the same driving lane as the ego vehicle) may be referred to as a car in front, a lead vehicle, a leading vehicle, or a preceding vehicle. A car that follows the ego vehicle (e.g., in the same driving lane as the ego vehicle) may be referred to as a car behind, a trailing vehicle, or a succeeding vehicle. A target vehicle may be any vehicle that is near the ego vehicle (e.g., within a threshold distance away from the ego vehicle) that the autonomous driving system is monitoring and/or analyzing. The target vehicle may be, for example, one or more lead vehicles and/or trailing vehicles.

In addition, terms such as first, second, A, B, (a), and (b) may be used to describe components of the example embodiments of the present disclosure.

These terms are only for the purpose of distinguishing one component from another component, and the nature, sequence, order, or the like of the corresponding components is not limited by these terms.

In addition, when a first component is described as being “connected,” “coupled,” or “joined” to a second component, it may include a case in which the first component is directly connected, coupled, or joined to the second component, but also a case in which the first component is “connected,” “coupled,” or “joined” to the second component by other components present between the first component and the second component.

In addition, when the first component is described as being formed or disposed on “on (above) or below (under)” the second component, “on (above)” or “below (under)” may include not only a case in which two components are in direct contact with each other, but also a case in which one or more third components are formed or disposed between the two components. In addition, when described as “on (above) or below (under),” it may include the meaning of not only an upward direction but also a downward direction based on one component.

Hereinafter, one or more example embodiments will be described in detail with reference to the accompanying drawings, and the same or corresponding components are denoted by the same reference numeral regardless of the reference numerals, and overlapping descriptions thereof will be omitted.

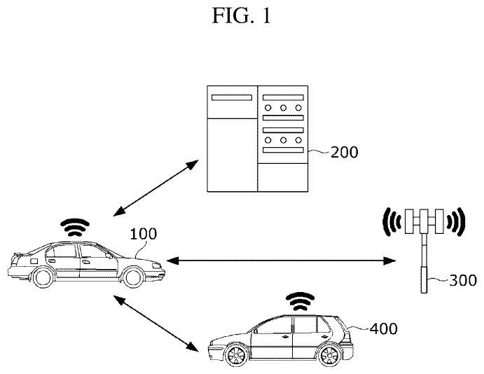

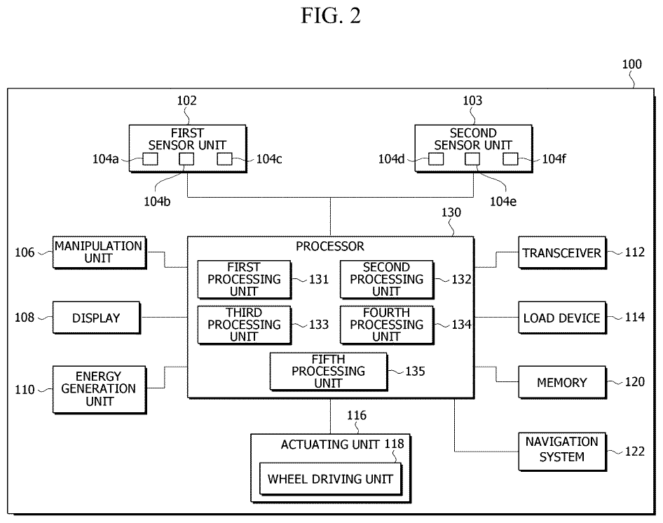

Hereinafter, a vehicle will be described with reference to FIGS. 1 and 2. FIG. 1 is a view showing an example vehicle communicating with other devices to transmit and receive data.

Referring to FIG. 1, a vehicle 100 may be driven based on electric energy or fossil energy. In the case of electric energy, the vehicle 100 may be, for example, a pure (e.g., full) battery-based vehicle driven by only a high-voltage battery or may adopt a gas-based fuel cell as an energy source. In addition, a fuel cell may use any form of gas that may generate electric energy, and the gas may fill the vehicle 100, for example, in a liquefied state. The gas may be, for example, hydrogen. However, the present disclosure is not limited thereto, and any gas may be applied. In the case of fossil energy, the vehicle 100 may be driven based on fuel such as gasoline, diesel, or liquefied gas and provided with an internal combustion engine that drives an actuating unit (also referred as an actuator) 116 by combustion of the fuel. The engine may be included in an energy generation unit (also referred to as an energy generator or an energy source) 110 from the perspective of providing a driving rotational force of a wheel to a wheel driving unit 118. As another example, the vehicle 100 may drive the actuating unit 116 selectively using an internal combustion engine based on fossil energy and the energy of an electric battery and may be a hybrid-type vehicle.

The vehicle 100 may refer to a mobile device. The vehicle 100 is a ground vehicle that travels on the ground and may be a typical passenger or commercial vehicle, a purpose-built vehicle (PBV), etc. The vehicle 100 may be a four-wheeled vehicle, for example, a passenger car, sport utility vehicle (SUV), a small truck, or a vehicle with more than four wheels, for example, a bus, a large truck, a container transport vehicle, a heavy equipment vehicle, or the like. The ground vehicle may include not only any vehicle that moves on land but also any vehicle that moves underground. The vehicle 100 may be a robot, and the robot may be moved using wheels, tracks, or other modes of locomotion. In the present disclosure, a ground mobility device such as a ground vehicle (e.g., an automobile) is mainly described, but unless it contradicts the present disclosure, the example embodiments may also be applied to air mobility devices such as an advanced air mobility (AAM) and an aircraft and water mobility devices such as a ship and a submarine.

The vehicle 100 may be driven by being controlled in an autonomous manner, and the autonomous driving may be implemented as semi-autonomous driving or fully autonomous driving. The fully autonomous driving may be provided as autonomous movement in which a processor 130 of the vehicle 100 has full control without user intervention even when a traveling situation is uncertain. The semi-autonomous driving may be provided as autonomous movement that requires driver intervention depending on a specific traveling situation. The semi-autonomous driving may be implemented such that manual driving is performed by a user after deactivating autonomous driving in the case of the above situation and transferring control authority to the user. According to the level of the autonomous driving defined by the Society of Automotive Engineers (SAE), the semi-autonomous driving corresponds to autonomous driving levels 1 to 4, and the full autonomous driving corresponds to level 5.

The vehicle 100 may communicate with devices 200 and 300 or another vehicle 400. The devices may include, for example, a server 200 (e.g., for supporting various control, state management, and driving of the vehicle 100), an intelligent transportation system (ITS) device 300 (e.g., for receiving information from an ITS), various types of user devices, etc. The server 200 may be, for example, an external device operated by a vehicle manufacturer or provided to service autonomous driving and may receive connected data of the vehicle 100 or transmit data required for autonomous driving. To support autonomous driving and various services of the vehicle 100, the server 200 may transmit, to the vehicle 100, various pieces of information and software modules that are used for controlling the vehicle 100 in response to the requests and pieces of data transmitted from the vehicle 100 and/or the user device.

The ITS device 300 may be, for example, a road side unit (RSU) and may exchange vehicle detection data, driving control and state data, environmental data near a vehicle, map data, or the like with the vehicle 100 through vehicle to infrastructure (V2I) to assist the user's driving or support the autonomous driving of the vehicle 100. The vehicle 100 may exchange the pieces of data listed above with another vehicle 400 through vehicle to vehicle (V2V) to support manual driving or autonomous driving.

The vehicle 100 may communicate with one or more other vehicles and/or other devices based on cellular communication, wireless access in vehicular environment (WAVE) communication, dedicated short range communication (DSRC), short-range communication, or other communication methods.

For example, the vehicle 100 may use a communication network such as Long Term Evolution (LTE) or 5G New Radio (NR), Wi-Fi communication network, WAVE communication network, etc. as a cellular communication network to communicate with the server 200, the ITS device 300, and another vehicle 400. As another example, the DSRC, etc. used in the vehicle 100 may be used for communication between vehicles. A communication method between the vehicle 100, the server 200, the ITS device 300, another vehicle 400, and the user device is not limited in this regard.

FIG. 2 is a view showing example components of a vehicle.

The vehicle 100 may include sensor units (e.g., one or more sensors) 102, 103, a manipulation unit (also referred to as a user interface) 106, a display 108, a load device 114, and a transceiver 112.

The first sensor unit 102 may include various types of detectors (e.g., sensors) for detecting various states and situations that occur in an external environment, internal system, user manipulation, and boarding space of the vehicle 100.

Specifically, the first sensor unit 102 may include an outer-facing camera (e.g., an exterior view camera) 104a, a light detection and ranging (LiDAR) sensor 104b, a radar sensor 104c, and the like to detect dynamic and static objects that are present outside the vehicle 100. The term “object” is used throughout this disclosure for the sake of convenience, but the term “object” as used herein may not only refer to any inanimate object that may be located in an exterior environment of a vehicle (e.g., a host vehicle) but it may also more broadly refer to any living things located in the exterior environment of the vehicle, such as a human (e.g., a pedestrian) or an animal (e.g., a dog).

The camera 104a may detect an external object in video while being used in the vehicle 100 to generate video data and transmit the video data to the processor 130. The LiDAR sensor 104b may generate point cloud data as detected data for an external object and transmit the point cloud data to the processor 130 in order to generate three-dimensional spatial information that identifies at least the shape of the external object. The radar sensor 104c may emit radio waves of a specific frequency to a peripheral area of the vehicle 100 to identify the presence of an external object, a relative distance, speed, direction, and the like to generate radar data through radio waves reflected from the external object. In the present disclosure, the LiDAR sensor 104b is provided as an example, but in another example, the LiDAR sensor 104b may not be mounted.

The first sensor unit 102 may generate object detection information (also referred to as pedestrian information) based on sensing data. The object detection information may include information about whether an object is present, position information of the object, distance information between the vehicle 100 and the object, and relative speed information between the vehicle 100 and the object. An external object may be various objects related to the operation of the vehicle 100.

A second sensor unit 103 may include a positioning sensor 104d, a wheel sensor 104e, an attitude sensor 104f, and the like to check a position, speed, driving attitude, and the like of the vehicle. The attitude sensor 104f may include a gyro sensor, an angular velocity sensor, an acceleration sensor, or the like. The attitude sensor may be an inertial measurement unit (IMU) sensor and may include a 3-axis accelerometer and a 3-axis angular velocity meter. The attitude sensor may measure acceleration in a movement direction x of the vehicle 100 (e.g., the longitudinal direction of the vehicle 100), acceleration in a transverse (e.g., lateral) direction y, acceleration in a height (e.g., vertical) direction z, and yaw, pitch, and roll as an angular speed of the vehicle.

The second sensor unit 103 may generate vehicle traveling information (also referred to as vehicle movement information) based on the sensing data. The vehicle traveling information may be information generated based on pieces of data detected by various sensors installed inside the vehicle. For example, the vehicle traveling information may include vehicle attitude information, vehicle speed information, vehicle tilt information, vehicle weight information, vehicle direction information, vehicle battery information, vehicle fuel information, vehicle tire pressure information, vehicle steering information, vehicle room temperature information, vehicle room humidity information, pedal position information, vehicle engine temperature information, and the like.

In addition, the vehicle traveling information may include route information. The route information may be information generated based on a destination input by a vehicle user through the manipulation unit 106. The route information may be information in which a traveling route from a current position of a host vehicle to a destination is displayed on map information when the destination is set. When the destination is not set, the route information may be information that includes a road on which the host vehicle is currently traveling and a future traveling route including the road.

The manipulation unit 106 (also referred to as the user interface 106) may be configured as a module manipulated by a user for driving. For example, the manipulation unit 106 may be a steering wheel for manual driving, an automatic or manual transmission, an accelerator pedal, a brake pedal, or the like. The manipulation unit 106 may further include an interface for using, deactivating, and selecting detailed functions of an autonomous driving mode requested by the user so that the user may use the autonomous driving function. The manipulation unit 106 may include, for example, a console, a dashboard, an instrument panel, a button, a knob, a slider, a touchscreen, etc. To receive various requests related to autonomous driving, the manipulation unit 106 may be composed of, for example, a hard type interface provided at a predetermined position inside the vehicle 100 or a soft type interface that may be touched on the display 108. According to the specifications of the autonomous vehicle, at least one of the steering wheel, the transmission, and the pedals may be omitted. As another example, the manipulation unit 106 may include a module that receives a user's control request for the load device 114 in addition to driving control.

The display 108 may serve as a user interface. The display 108 may display an operation state of the vehicle 100, a control state, route/traffic information, the remaining energy information, a content requested by the driver, and the like to be output by the processor 130. In addition, the display 108 may be configured as a touch screen capable of detecting the driver's input to receive the driver's request that instructs the processor 130.

The load device 114 may be mounted on the vehicle 100 and may be a type of non-driving electric device excluding a driving power system such as the wheel driving unit 118. The load device 114 is an auxiliary device for receiving power from the energy generation unit 110 and may be, for example, any of various devices installed in an air conditioning system, a lighting system, a seat system, and the vehicle 100. In the present disclosure, a cooling/heating system for cooling or heating at least one of a battery, a fuel cell, an internal combustion engine, an air conditioning system, and a specific area of the vehicle 100 may be further included.

The transceiver 112 may support mutual communication with the server 200, the ITS device 300, the nearby vehicle 300, and the like. The transceiver 112 may include, for example, a module for processing cellular communication, WAVE, DSRC communication, or the like. In the present disclosure, the transceiver 112 may transmit data generated or stored during driving to the server 200 and receive a data and software module transmitted from the server 200. The transceiver 112 may support communication with an electronic device of a passenger inside the vehicle 100. In the present disclosure, the vehicle 100 may transmit and receive data used in the method according to the present disclosure with an external device through the transceiver 112.

For example, the transceiver 112 may receive traffic signal information from a traffic signal controller and provide the traffic signal information to the processor 130. In addition, the transceiver 112 may receive control signals from the traffic signal controller and provide control signals to the processor 130.

In addition, the vehicle 100 may include the energy generation unit 110 and the actuating unit 116.

The energy generation unit 110 (e.g., an energy source) may generate and supply power and electric power that are used in a driving power system and a non-driving power system, such as the actuating unit 116 (e.g., a motor). The non-driving power system may include, for example, the sensor unit 102, the manipulation unit 106, the display 108, the load device 114, the transceiver 112, and the like but is not limited thereto, and may include any of various components that implement sensing, interface, communication, and convenience functions other than components directly involved in a driving operation. If the vehicle 100 is driven based on electric energy, the energy generation unit 110 may be configured as, for example, an electric battery charged from the outside or configured as a combination of an electric battery and a fuel cell that charges the battery. In the case of a combination of the electric battery and the fuel cell, the energy generation unit 110 may include a tank (e.g., a fuel tank) that stores a material used to produce power for the fuel cell, for example, liquefied hydrogen. If the vehicle 100 is driven based on fossil energy, the energy generation unit 110 may be configured as an internal combustion engine. In addition, if the vehicle 100 is a hybrid type, the energy generation unit 110 may be provided as a combination of the internal combustion engine and the electric battery.

The actuating unit 116 may include at least one module that implements a driving operation and may perform at least one driving operation of longitudinal control such as acceleration and deceleration and lateral control such as steering according to a user request from the manipulation unit 106. To perform the driving operation according to the user's manual manipulation or the instruction of the processor 130 by autonomous driving, the actuating unit 116 may include the wheel driving unit 118, and a mechanical component and electronic module for implementing the driving operation of the wheel driving unit 118. When the vehicle 100 is operated based on electric energy, the vehicle 100 may include an assembly for transmitting the requested driving operation to the wheel driving unit 118. When the vehicle 100 is operated based on fossil energy, the actuating unit 116 may include a transmission and a gear module for transmitting the power of an internal combustion engine.

The wheel driving unit 118 may include a plurality of wheels, a driving force generation module for generating and applying a driving force to wheels or transmitting the driving force, a braking module for decelerating the driving of the wheels, a steering module for achieving transverse (e.g., lateral) control of the wheels. When the vehicle 100 is driven based on electric energy, the driving force generation module may be configured as a motor assembly for generating a driving force based on power output from the electric battery. The braking module of the electricity-based vehicle 100 may further have a regenerative braking function.

A navigation system 122 may provide navigation information. The navigation system 122 may be a global positioning system (GPS) device. The navigation information may include at least one of map information, set destination information, route information according to destination setting, information about various objects on a route, lane information, and current position information of the vehicle.

The navigation system 122 may receive information from an external device through the transceiver 112 and update previously stored information. The navigation system 122 may be classified as a subcomponent of the manipulation unit 106.

In addition, the vehicle 100 may include a memory 120 and a processor 130.

The memory 120 may store an application and various pieces of data for controlling the vehicle 100 and load the application or read or write the data at the request of the processor 130.

The processor 130 may perform the overall control of the vehicle 100. The processor 130 may be configured to execute applications and instructions that are stored in the memory 120.

The processor 130 may include a first processing unit 131, a second processing unit 132, a third processing unit 133, a fourth processing unit 134, and a fifth processing unit 135. Each of the processing units 131, 132, 133, 134, 135 may be implemented with software (e.g., independently operated threads, processes, applications, etc.), hardware (e.g., CPUs, cores, circuits, etc.), or a combination of both. Two or more of the processing units 131, 132, 133, 134, 135 may be combined or integrated into one. Each of the processing units 131, 132, 133, 134, 135 may be referred to as a process, which can be executed independently from one another to perform various tasks consecutively (e.g., serially), concurrently (e.g., in parallel), or both consecutively and concurrently. A process may be a separate independent hardware processor or it may be a software process that is executing in foreground or in background.

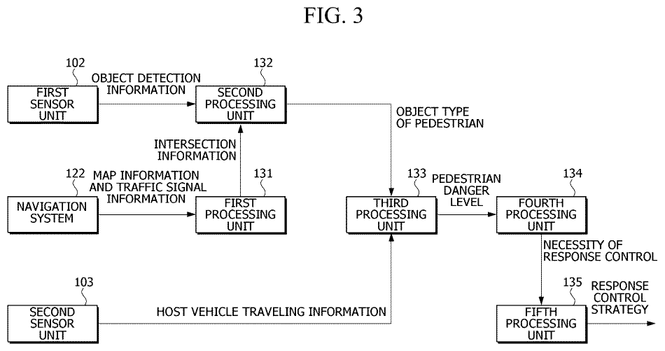

FIG. 3 is a view for describing an example operation of a processor. Referring to FIG. 3 together, the first processing unit 131 may determine (e.g., classify) intersection information using map information and traffic signal information. The intersection information may include information about one or more road intersections (e.g., at-grade junctions), such as information about position(s), shape(s), dimension(s), object(s) (e.g., traffic signages, traffic lights), crosswalk(s), traffic signaling (e.g., timing, pattern, etc.), and so forth related to each intersection.

The first processing unit 131 may collect high-resolution map information including a position of the intersection from the navigation system 122. The map information may include the layout of the road, the position of the intersection, the width of the road, lane information, and the like.

The first processing unit 131 may collect position information near the intersection using GPS data collected from the navigation system 122 of the vehicle.

The first processing unit 131 may identify an intersection area near (e.g., within a threshold distance) a host vehicle from the map information. The first processing unit 131 may identify an intersection area from the map information using an image processing algorithm (e.g., edge detection or area partition).

The first processing unit 131 may convert the identified intersection area into a vector format to define a boundary line constituting the intersection area. The first processing unit 131 may additionally use geographic information system (GIS) data to identify the shape of the intersection, the number of roads approaching in each direction, the number of lanes, and the like.

The first processing unit 131 may extract the intersection area from the map information and determine (e.g., calculate) a remaining distance and a remaining time to a crosswalk and a stop line (e.g., a stop line associated with a crosswalk) in the intersection area according to host vehicle traveling information.

The first processing unit 131 may determine (e.g., calculate) current states and state change times of traffic lights disposed in the intersection area if traffic signal information is required according to the host vehicle route included in the host vehicle traveling information (e.g., if the route of the host vehicle passes through an intersection with a traffic light).

The first processing unit 131 may determine (e.g., calculate) a remaining distance and a remaining time to the crosswalk and the stop line disposed in the intersection area when the traffic signal information is not required according to the host vehicle route included in the host vehicle traveling information.

The first processing unit 131 may collect the states and change cycles of the traffic lights (e.g., traffic pattern) installed in the intersection through the transceiver. The first processing unit 131 may check the current state (e.g., red light, green light, yellow light) of the traffic light in real time through the connection of the traffic signal controller or traffic light sensor data.

The first processing unit 131 may analyze the cycle of the traffic lights and determine (e.g., calculate) the duration of each state. The first processing unit 131 may determine (e.g., calculate) the remaining time until the state of each traffic light is changed based on the current traffic light state and cycle information.

The first processing unit 131 may determine (e.g., calculate) current states and state change times of the traffic lights disposed on the host vehicle route when the host vehicle route in the intersection area is straight, a left turn, or a U-turn. In addition, the first processing unit 131 may determine (e.g., calculate) a remaining distance and a remaining time to at least one of all stop lines and crosswalks on the host vehicle route. The first processing unit 131 may determine (e.g., calculate) a remaining distance and a remaining time to at least one of the stop lines and crosswalks using the host vehicle traveling information collected from the second sensor unit 103.

Alternatively, if the host vehicle route in the intersection area is an unprotected left turn, an unprotected U-turn, a right turn, or a signal-less passage, the first processing unit 131 may determine (e.g., calculate) a remaining distance and a remaining time to at least one of all stop lines and crosswalks on the host vehicle route. The first processing unit 131 may determine (e.g., calculate) a remaining distance and a remaining time to at least one of the stop lines and crosswalks using the host vehicle traveling information collected from the second sensor unit 103.

The second processing unit 132 may classify the object type (also referred to as the pedestrian type) according to the pedestrian's position using object detection information. The second processing unit 132 may determine a pedestrian near the host vehicle using the object detection information generated by the first sensor unit 102. The second processing unit 132 may partition the area near the host vehicle into a plurality of areas according to the attribute of the road. The second processing unit 132 may classify the object type of the pedestrian according to the attribute of the area in which the pedestrian is positioned. In addition, the second processing unit 132 may determine (e.g., calculate) a linear distance between a boundary line of each area and the pedestrian.

For example, the second processing unit 132 may classify the area near the host vehicle as a crosswalk, a roadway, a sidewalk, and/or a bicycle lane. If the attribute of the area in which the pedestrian around the host vehicle is positioned is a crosswalk, the second processing unit 132 may classify the object type of the corresponding pedestrian as a crosswalk pedestrian. If the attribute of the area in which the pedestrian near the host vehicle is positioned is a roadway, the second processing unit 132 may classify the object type of the corresponding pedestrian as a roadway pedestrian. If the attribute of the area in which the pedestrian near the host vehicle is positioned is a sidewalk, the second processing unit 132 may classify the object type of the corresponding pedestrian as a sidewalk pedestrian. If the attribute of the area in which the pedestrian near the host vehicle is positioned is a bicycle lane, the second processing unit 132 may classify the object type of the corresponding pedestrian as a bicycle lane pedestrian.

The third processing unit 133 may determine a pedestrian danger level using the object type of the pedestrian and the host vehicle traveling information.

The third processing unit 133 may determine (e.g., calculate) a predicted path of the pedestrian based on the object type of the pedestrian. The third processing unit 133 may determine (e.g., calculate) the predicted path of the pedestrian using the object type of the pedestrian and the linear distance between the boundary line of each area and the pedestrian. The third processing unit 133 may compare (e.g., sequentially compare) the object detection information of the first sensor unit 102 in time order to determine (e.g., calculate) the predicted path of the pedestrian. For example, the third processing unit 133 may compare a linear distance between a boundary line of an area determined (e.g., calculated) at a previous time (t−1) and a pedestrian with a linear distance between a boundary line of an area determined (e.g., calculated) at a current time (t) and a pedestrian to determine (e.g., calculate) the predicted path of the pedestrian. The third processing unit 133 may determine (e.g., calculate) a predicted moving speed of the pedestrian using a moving distance of the pedestrian over time.

The third processing unit 133 may determine (e.g., calculate) the predicted path of the pedestrian using the object type of the pedestrian. The third processing unit 133 may determine the attribute of another area positioned in a direction of a boundary line of an area in which the pedestrian approaches and determine the predicted path of the pedestrian based on the corresponding attribute. For example, when the object type of the current pedestrian is a sidewalk pedestrian and the pedestrian gets closer to the boundary line with the crosswalk area in a current time zone compared to the previous time, the third processing unit 133 may determine (e.g., calculate) the predicted path of the pedestrian as the corresponding pedestrian moving from the sidewalk to the crosswalk.

The third processing unit 133 may analyze a convergence possibility between the predicted path of the pedestrian and the host vehicle route included in the host vehicle traveling information. In other words, the convergence possibility may be, for example, a predicted chance (e.g., likeliness) that the predicted path of the pedestrian may converge, intersect, or collide with the route of the host vehicle. The third processing unit 133 may determine (e.g., calculate) the position of the pedestrian at a future time using the predicted path of the pedestrian and the predicted moving speed of the pedestrian. In addition, the third processing unit 133 may determine (e.g., calculate) the position of the host vehicle at the future time based on the traveling speed of the host vehicle and the host vehicle route according to the host vehicle traveling information. The third processing unit 133 may compare the position of the pedestrian with the position of the host vehicle at the future time and determine a case in which positions of the pedestrian and the host vehicle converge (e.g., intersect, collide, etc.) at the same future time.

The third processing unit 133 may analyze an convergence possibility between the pedestrian and the host vehicle using the intersection information determined (e.g., calculated) by the first processing unit 131. That is, the third processing unit 133 may additionally use a case in which the host vehicle stops at an intersection according to the intersection information to analyze the intersection possibility with the pedestrian.

In the case of the pedestrian with the convergence possibility (e.g., possibility or likelihood above a threshold level), the third processing unit 133 may determine (e.g., calculate) a convergence point (e.g., a location of convergence) with the host vehicle route, a predicted convergence time, and longitudinal and transverse (e.g., lateral) distances between the host vehicle route and the pedestrian using the host vehicle traveling information and the predicted path of the pedestrian to determine a pedestrian danger level. The third processing unit 133 may analyze the positions of the host vehicle and the pedestrian at a future time when intersection is predicted and determine (e.g., calculate) the convergence point with the host vehicle route and the predicted convergence time.

In addition, the third processing unit 133 may determine (e.g., calculate) the longitudinal and transverse (e.g., lateral) distances between the host vehicle and the pedestrian using the positions of the host vehicle and the pedestrian at the predicted convergence time.

The third processing unit 133 may compare the longitudinal and transverse (e.g., lateral) distances between the host vehicle and the pedestrian at the predicted convergence time with preset first reference longitudinal and transverse distances to determine the pedestrian danger level. The pedestrian danger level may be an ordinal level. For example, the third processing unit 133 may determine that the pedestrian danger level is Level 6 when the longitudinal and transverse distances between the host vehicle and the pedestrian at the predicted convergence time are smaller than the first reference longitudinal and transverse distances. Alternatively, the third processing unit 133 may determine that the pedestrian danger level is Level 5 when one of the longitudinal and transverse distances between the host vehicle and the pedestrian at the predicted convergence time is smaller than the first reference longitudinal and transverse distances. Alternatively, the third processing unit 133 may determine that the pedestrian danger level is Level 4 when the longitudinal and transverse distances between the host vehicle and the pedestrian at the predicted convergence time are the first reference longitudinal and transverse distances or more.

In the case of a pedestrian with no intersection possibility, the third processing unit 133 may determine (e.g., calculate) the longitudinal and transverse (e.g., lateral) distances between the host vehicle route and the pedestrian using the host vehicle traveling information and the predicted path of the pedestrian to determine the pedestrian danger level. The third processing unit 133 may compare the longitudinal and transverse distances between the host vehicle and the pedestrian at the future time with preset second reference longitudinal and transverse distances to determine the pedestrian danger level. For example, the third processing unit 133 may determine that the pedestrian danger level is Level 3 when the longitudinal and transverse distances between the host vehicle and the pedestrian at the future time are smaller than the second reference longitudinal and transverse distances. Alternatively, the third processing unit 133 may determine that the pedestrian danger level is Level 2 when one of the longitudinal and transverse distances between the host vehicle and the pedestrian at the future time is smaller than the second reference longitudinal and transverse distances. Alternatively, the third processing unit 133 may determine that the pedestrian danger level is Level 1 when the longitudinal and transverse distances between the host vehicle and the pedestrian at the future time are the first reference longitudinal and transverse distances or more.

The first reference longitudinal distance may have a smaller value than the second reference longitudinal distance, and the first reference transverse (e.g., lateral) distance may have a smaller value than the second reference transverse distance.

The pedestrian danger level may mean that Level 6 is the highest risk level and Level 1 is the lowest risk level. However, unlike this, a more subdivided danger level may be set using various reference distances and conditions.

The fourth processing unit 134 may determine the necessity of response control of the host vehicle according to the pedestrian danger level. The fourth processing unit 134 may determine that the response control of the host vehicle is required when the pedestrian danger level is the preset reference level or higher. For example, the fourth processing unit 134 may determine that the response control of the host vehicle is required when the pedestrian danger level is Level 3 or higher.

The fourth processing unit 134 may control the vehicle based on the necessity of response control of the host vehicle. The fourth processing unit 134 may select a deceleration control response or a stop control response control strategy according to the pedestrian danger level.

The fourth processing unit 134 may determine (e.g., calculate) the reliability of the pedestrian depending on whether a previous response control strategy for the pedestrian is output and determine the necessity of response control of the host vehicle based on the pedestrian danger level and the reliability of the pedestrian. The fourth processing unit 134 may review previous response control strategy determination (e.g., calculation) histories for the same pedestrian. The fourth processing unit 134 may determine (e.g., calculate) the reliability of the pedestrian using a control time, a control distance, and the number of times response control when a deceleration control response is performed on the same pedestrian. In addition, the fourth processing unit 134 may determine (e.g., calculate) the reliability of the pedestrian using a control time, a control distance, and the number of times response control when a stop control response is performed on the same pedestrian. The fourth processing unit 134 may determine (e.g., calculate) the higher reliability of the pedestrian as the control time in the previous response control strategy is kept longer and the control distance becomes longer. In addition, the fourth processing unit 134 may determine (e.g., calculate) the higher reliability of the pedestrian as the number of times continuous response controls increases.

In addition, the fourth processing unit 134 may determine whether another object is positioned on (e.g., along) the host vehicle route and the predicted path of the pedestrian using the object detection information and determine the necessity of response control of the host vehicle depending on whether another object is present. The fourth processing unit 134 may determine whether another object is present between the host vehicle and the pedestrian at the future time or the predicted convergence time using the object detection information of the first sensor unit 102. Since a case in which another object is present on the host vehicle route and a predicted path of a first pedestrian at a specific future time or a predicted convergence time and the corresponding object is a second pedestrian is a case in which the response control strategy for the second pedestrian has already been determined (e.g., calculated), the response control strategy for the first pedestrian is not determined (e.g., calculated). Therefore, the fourth processing unit 134 may determine that the response control of the host vehicle is not required when it is determined that another pedestrian is present between the host vehicle route and the pedestrian at the specific future time or the predicted convergence time.

If it is determined that there is a need for the response control, the fifth processing unit 135 may determine (e.g., calculate) a response control strategy for at least one of stop response control and deceleration response control according to the pedestrian danger level. The fifth processing unit 135 may determine (e.g., calculate) a response control strategy according to the pedestrian danger level. For example, the fifth processing unit 135 may determine (e.g., calculate) the response control strategy as a stop response strategy if the pedestrian danger level is Level 4 or higher. Alternatively, the fifth processing unit 135 may determine (e.g., calculate) the response control strategy as a deceleration response strategy when the pedestrian danger level is Level 3 or higher.

The fifth processing unit 135 may not additionally determine whether to determine (e.g., calculate) the deceleration response strategy for a pedestrian for whom the stop response strategy has been determined (e.g., calculated). That is, the stop response strategy may be preferentially applied to the deceleration response strategy. Therefore, when the pedestrian danger level is Level 4 or higher, both the deceleration response strategy and the stop response strategy may be applied, but only the stop response strategy may be preferentially applied to the deceleration response strategy.

In the case of the deceleration response strategy, the fifth processing unit 135 may determine (e.g., calculate) a deceleration control time and a deceleration control distance according to at least one of an intersecting point with the host vehicle route, a predicted convergence time, and longitudinal and transverse (e.g., lateral) distances between the host vehicle route and the pedestrian.

In the case of the stop response strategy, the fifth processing unit 135 may determine (e.g., calculate) a stop control time and a stop control distance according to at least one of a convergence point with the host vehicle route, a predicted convergence time, and longitudinal and transverse distances between the host vehicle route and the pedestrian.

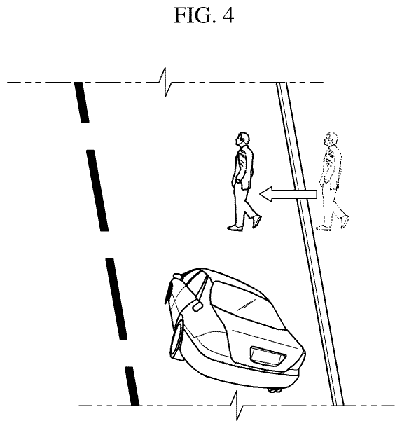

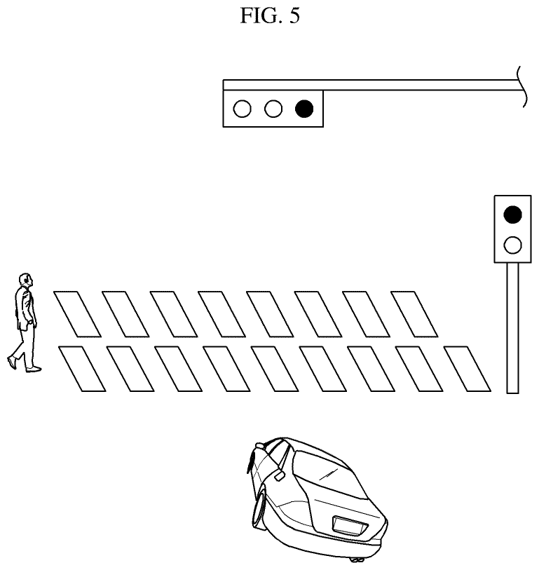

FIGS. 4 and 5 are conceptual diagrams for describing example response control strategies of a vehicle.

FIG. 4 shows a case in which the host vehicle route and the pedestrian danger level are determined (e.g., calculated), and the intention of a pedestrian classified as a sidewalk pedestrian to cross from the sidewalk to the road is analyzed using the host vehicle route and the pedestrian danger level to determine (e.g., calculate) the stop response strategy.

FIG. 5 shows a case in which the host vehicle route and the pedestrian danger level are determined (e.g., calculated), and the intention of a pedestrian classified as a crosswalk pedestrian in a state in which the traffic light is red to cross illegally is analyzed through intersection information to determine (e.g., calculate) the stop response strategy.

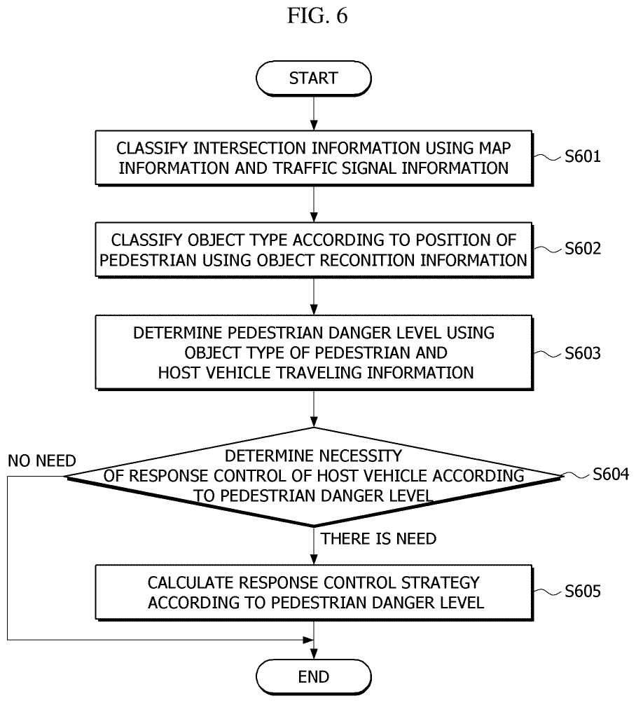

FIG. 6 is a flowchart of an example method of controlling a vehicle. Referring to FIG. 6, first, the processor classifies intersection information using map information and traffic signal information (S601).

The processor classifies the object type according to the position of the pedestrian using object detection information (S602).

The processor determines a pedestrian danger level using the object type of the pedestrian and host vehicle traveling information (S603).

The processor determines the necessity of the host vehicle response control according to the pedestrian danger level (S604).

If it is determined that there is a need for the response control, the processor may determine (e.g., calculate) a response control strategy for at least one of stop response control and deceleration response control according to the pedestrian danger level (S605).

Hereinafter, an operating process of each operation will be described in detail.

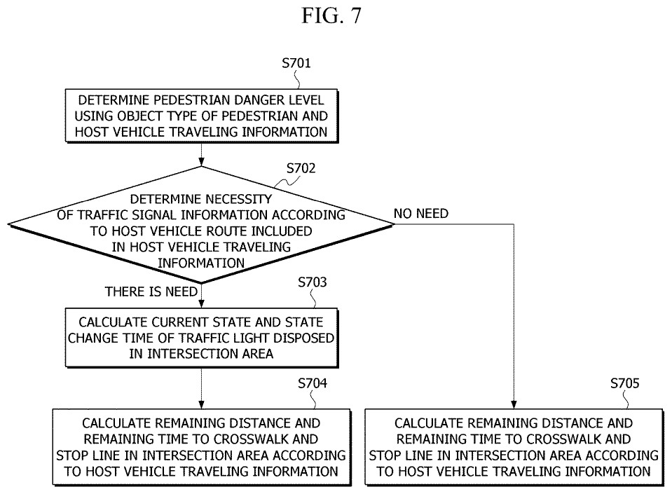

FIG. 7 is a flowchart for describing an example operating process of S601 of FIG. 6. Referring to FIG. 7, the processor extracts an intersection area from map information (S701).

The processor determines the necessity of traffic signal information according to the host vehicle route included in the host vehicle traveling information (S702).

If the traffic signal information is required, the processor may determine (e.g., calculate) current states and state change times of traffic lights disposed in an intersection area (S703).

The processor may determine (e.g., calculate) a remaining distance and a remaining time to a crosswalk and a stop line (e.g., a stop line associated with a crosswalk) in the intersection area according to the host vehicle traveling information (S704).

Alternatively, when the traffic signal information is not required, the processor may determine (e.g., calculate) a remaining distance and a remaining time to the crosswalk and the stop line in the intersection area based on the host vehicle traveling information (S705).

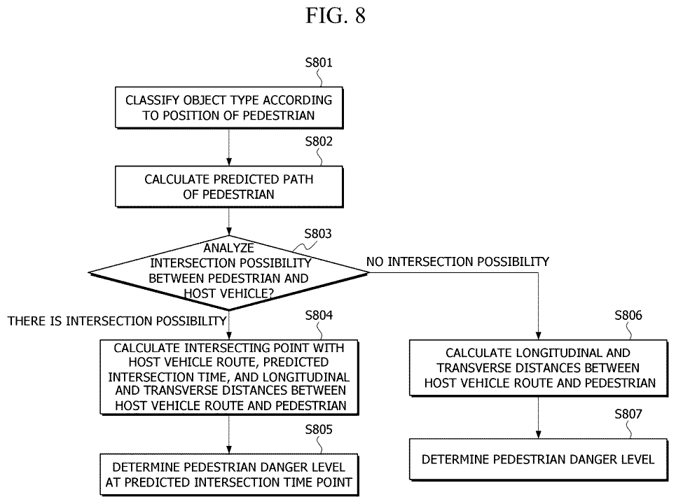

FIG. 8 is a flowchart for describing example operating processes of S602 and S603 of FIG. 6. Referring to FIG. 8, the processor classifies the object type according to the position of the pedestrian in the intersection area using the intersection information and object detection information (S801).

The processor may determine (e.g., calculate) a predicted path of the pedestrian according to the object type of the pedestrian (S802).

The processor analyzes a possibility or likelihood of convergence (also referred to as a convergence possibility) between the predicted path of the pedestrian and the host vehicle route included in the host vehicle traveling information (S803).

In the case of a pedestrian with the convergence possibility, the processor may determine (e.g., calculate) a convergence point with the host vehicle route, a predicted convergence time, and longitudinal and transverse (e.g., lateral) distances between the host vehicle route and the pedestrian using the host vehicle traveling information and the predicted path of the pedestrian (S804).

The processor compares the longitudinal and transverse distances between the host vehicle and the pedestrian at a predicted convergence time with preset first reference longitudinal and transverse (e.g., lateral) distances to determine a pedestrian danger level (S805).

Alternatively, in the case of a pedestrian with little or no possibility (e.g., likelihood below a threshold level) of convergence, the processor may determine (e.g., calculate) the longitudinal and transverse (e.g., lateral) distances between the host vehicle route and the pedestrian using the host vehicle traveling information and the predicted path of the pedestrian (S806).

The processor compares the longitudinal and transverse (e.g., lateral) distances between the host vehicle and the pedestrian at a future time with preset second reference longitudinal and transverse distances to determine the pedestrian danger level (S807).

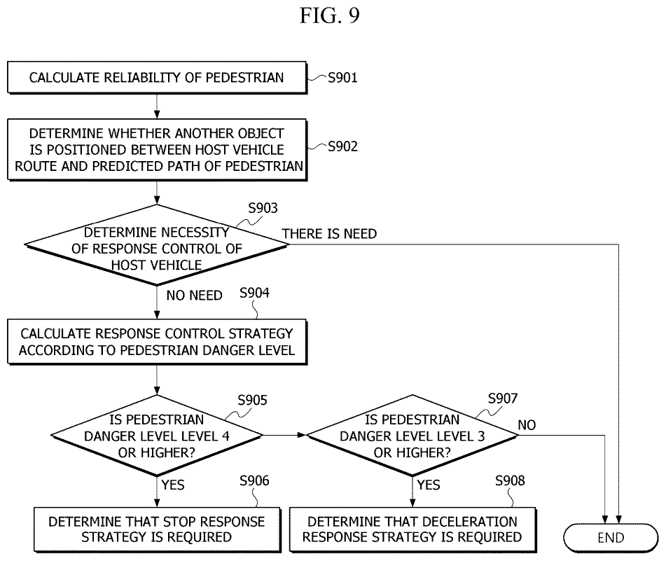

FIG. 9 is a flowchart for describing an example operating process of S604 of FIG. 6. Referring to FIG. 9, the processor may determine (e.g., calculate) the reliability of the pedestrian depending on whether a previous response control strategy for the pedestrian is output (S901).

Subsequently or at the same time, the processor determines whether another object is positioned between the host vehicle route and the predicted path of the pedestrian using object detection information (S902).

The processor determines the necessity of response control of the host vehicle based on the pedestrian danger level, the presence or absence of another object, and reliability. For example, the processor determines that the response control is not required when another pedestrian is positioned between the pedestrian and the host vehicle. In addition, the processor determines that the response control strategy is required when the pedestrian danger level and the reliability are a predetermined level or more (S903).

When it is determined that there is a need for the response control, the processor may determine (e.g., calculate) a response control strategy for at least one of stop response control and deceleration response control according to the pedestrian danger level (S904).

When the pedestrian danger level is Level 4 or higher, the processor determines that the stop response strategy is required (S905 and S906).

Alternatively, when the pedestrian danger level is Level 3, the processor determines that the deceleration response strategy is required (S907 and S908).

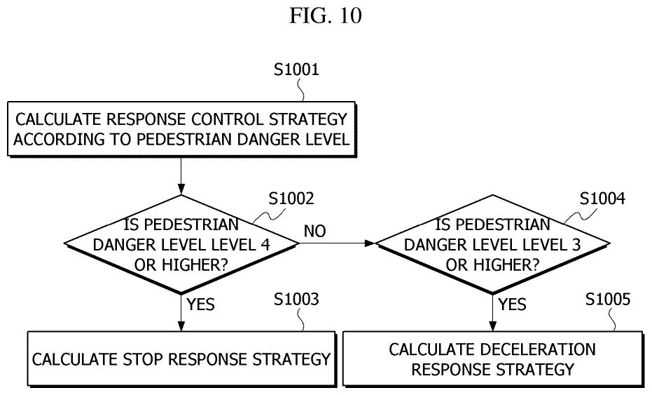

FIG. 10 is a flowchart for describing an example operating process of S605 of FIG. 6. Referring to FIG. 10, the processor may determine (e.g., calculate) a response control strategy according to the pedestrian ranger level (S1001).

When the pedestrian danger level is Level 4 or higher, the processor may determine (e.g., calculate) the response control strategy as a stop response strategy. The processor may determine (e.g., calculate) a stop control time and stop control distance according to at least one of a convergence point with the host vehicle route, a predicted time of convergence, and longitudinal and transverse (e.g., lateral) distances between the host vehicle route and the pedestrian (S1002 and S1003).

The processor does not additionally determine whether to determine (e.g., calculate) the deceleration response strategy for the pedestrian for whom the stop response strategy has been determined (e.g., calculated).

Alternatively, the processor may determine (e.g., calculate) the response control strategy as a deceleration response strategy when the pedestrian danger level is Level 3 or higher. The processor may determine (e.g., calculate) a deceleration control time and deceleration control distance according to at least one of a point of convergence with the host vehicle route, a predicted time of convergence, and longitudinal and transverse (e.g., lateral) distances between the host vehicle route and the pedestrian (S1004, S1005).

The term “unit” used in the example embodiments may refer to a software or hardware component such as a field-programmable gate array (FPGA) or an ASIC, and the “unit” performs certain roles. However, the “unit” is not limited to software or hardware. The “unit” may be configured to be disposed in an addressable storage medium and configured to reproduce one or more processors. Therefore, as an example, the “unit” is components such as software components, object-oriented software components, class components, and task components, processes, functions, attributes, procedures, subroutines, segments of program code, drivers, firmware, microcode, circuits, data, database, data structures, tables, arrays, and variables. Functions provided in the components and “units” may be combined into the smaller number of components and “unit” or separated into additional components and “units.” Additionally, the components and “units” may be implemented to reproduce one or more CPUs in a device or a security multimedia card.

There is provided a vehicle including one or more processors and a memory configured to store one or more programs executed by the one or more processor, wherein the processor includes a first processing unit configured to classify intersection information using map information and traffic signal information, a second processing unit configured to classify an object type according to a position of a pedestrian using object detection information, a third processing unit configured to determine a pedestrian danger level using the object type of the pedestrian and host vehicle traveling information, and a fourth processing unit configured to determine necessity of response control of the host vehicle according to the pedestrian danger level and control the vehicle based on the necessity of response control of the host vehicle.

The first processing unit may extract an intersection area from the map information and calculate a remaining distance and a remaining time to a crosswalk and a stop line in the intersection area according to the host vehicle traveling information.

The first processing unit may calculate a current state and a state change time of a traffic light disposed in the intersection area when the traffic signal information is required according to a host vehicle route included in the host vehicle traveling information.

The second processing unit may classify the object type of the pedestrian according to an attribute of an area in which the pedestrian is positioned.

The third processing unit may calculate a predicted path of the pedestrian according to the object type of the pedestrian.

The third processing unit may analyze an intersection possibility between the predicted path of the pedestrian and a host vehicle route included in the host vehicle traveling information.

In the case of a pedestrian with the intersection possibility, the third processing unit may calculate an intersecting point with the host vehicle route, a predicted intersection time, and longitudinal and transverse distances between the host vehicle route and the pedestrian using the host vehicle traveling information and the predicted path of the pedestrian to determine the pedestrian danger level.

In the case of a pedestrian with no intersection possibility, the third processing unit may calculate longitudinal and transverse distances between the host vehicle route and the pedestrian using the host vehicle traveling information and the predicted path of the pedestrian to determine the pedestrian danger level.

The vehicle may further include a fifth processing unit configured to calculate a response control strategy for at least one of stop response control and deceleration response control according to the pedestrian danger level when it is determined that there is a need for the response control.

The fourth processing unit may calculate the reliability of the pedestrian depending on whether a previous response control strategy for the pedestrian is output and determine the necessity of the response control of the host vehicle based on the pedestrian danger level and the reliability.

The fourth processing unit may determine whether another object is positioned on a host vehicle route and a predicted path of the pedestrian using the object detection information and determine the necessity of the response control of the host vehicle depending on whether the other object is present.

There is provided a method of controlling a vehicle, which is performed by a computing device including one or more processors and a memory configured to store one or more programs executed by the one or more processors, which includes classifying, by the processor, intersection information using map information and traffic signal information, classifying an object type according to a position of a pedestrian using object detection information, determining a pedestrian danger level using the object type of the pedestrian and host vehicle traveling information, determining necessity of response control of the host vehicle according to the pedestrian danger level and controlling the vehicle based on the necessity of response control of the host vehicle.

The classifying of the intersection information may include extracting an intersection area from the map information, and calculating a remaining distance and a remaining time to a crosswalk and a stop line of the intersection area according to the host vehicle traveling information.

The classifying of the intersection information may further include calculating a current state and a state change time of a traffic light disposed in the intersection area when the traffic signal information is required according to a host vehicle route included in the host vehicle traveling information.

The classifying of the object type may include classifying the object type of the pedestrian according to an attribute of an area in which the pedestrian is positioned.

The determining of the pedestrian danger level may include calculating a predicted path of the pedestrian according to the object type of the pedestrian, and analyzing an intersection possibility between the predicted path of the pedestrian and a host vehicle route included in the host vehicle traveling information.

The determining of the pedestrian danger level may further include calculating, in the case of a pedestrian with the intersection possibility, an intersecting point with the host vehicle route, a predicted intersection time, and longitudinal and transverse distances between the host vehicle route and the pedestrian using the host vehicle traveling information and the predicted path of the pedestrian, and determining the pedestrian danger level using the intersecting point with the host vehicle route, the predicted intersection time, and the longitudinal and transverse distances between the host vehicle route and the pedestrian.

The determining of the pedestrian danger level may further include calculating, in the case of a pedestrian with no intersection possibility, longitudinal and transverse distances between the host vehicle route and the pedestrian using the host vehicle traveling information and the predicted path of the pedestrian, and determining the pedestrian danger level using the longitudinal and transverse distances between the host vehicle route and the pedestrian.

The method may further include calculating a response control strategy for at least one of stop response control and deceleration response control according to the pedestrian danger level when it is determined that there is a need for the response control.

The determining of the necessity of the response control of the host vehicle may include calculating reliability of the pedestrian depending on whether a previous response control strategy for the pedestrian is output, determining whether another object is positioned on the host vehicle route and the predicted path of the pedestrian using the object detection information, and determining the necessity of the response control of the host vehicle based on the pedestrian danger level, whether the other object is present, and the reliability.

According to a vehicle and a method of controlling the same according to one or more example embodiments, a pedestrian's intention can be determined, thereby classifying a pedestrian danger level.

In addition, response control necessity of a host vehicle can be determined according to a pedestrian danger level.

In addition, a response control strategy for a host vehicle can be established according to a pedestrian danger level.

Although the present disclosure has been described above with reference to example embodiments, those skilled in the art will understand that the present disclosure may be modified and changed variously without departing from the spirit and scope of the present disclosure as described in the appended claims.

What is claimed is:

1. A vehicle comprising:
one or more sensors configured to detect a pedestrian in an exterior environment of the vehicle;
one or more processors; and
a memory storing at least one instruction that is configured, when executed by the one or more processors communicating with the memory, to cause the vehicle to execute:
a first process configured to determine, based on map information and traffic signal information, intersection information regarding an intersection associated with the vehicle;
a second process configured to:
receive, from the one or more sensors, pedestrian information regarding the pedestrian; and
determine, based on the pedestrian information indicating a position of the pedestrian, a pedestrian type of the pedestrian;
a third process configured to determine, based on the pedestrian type of the pedestrian and further based on vehicle movement information of the vehicle, a pedestrian danger level; and
a fourth process configured to control, based on the pedestrian danger level, an autonomous driving operation of the vehicle.

2. The vehicle of claim 1, wherein the first process is configured to determine the intersection information by:
determining, based on the map information, the intersection; and
determining, based on the vehicle movement information, a remaining distance and a remaining time to a stop line associated with a crosswalk in the intersection.

3. The vehicle of claim 1, wherein the first process is further configured to:
determine, based on a route of the vehicle passes through the intersection having a traffic light, a current state and a state change time of the traffic light.

4. The vehicle of claim 1, wherein the second process is configured to determine the pedestrian type based on an attribute of an area in which the pedestrian is positioned.

5. The vehicle of claim 1, wherein the third process is configured to determine the pedestrian danger level by:
determining, based on the pedestrian type, a predicted path of the pedestrian.

6. The vehicle of claim 5, wherein the third process is configured to determine the pedestrian danger level further by:
determining, based on the vehicle movement information, a likelihood value of convergence of the predicted path of the pedestrian and a route of the vehicle.

7. The vehicle of claim 6, wherein the third process is configured to determine the pedestrian danger level further by:
determining, based on the likelihood value of the convergence being above a threshold and using the vehicle movement information and the predicted path of the pedestrian, a predicted location of the convergence, a predicted time of the convergence, a longitudinal distance between the route and the pedestrian, and a lateral distance between the route and the pedestrian.

8. The vehicle of claim 6, wherein the third process is configured to determine the pedestrian danger level further by:
determining, based on the likelihood value of the convergence being below a threshold and using the vehicle movement information and the predicted path of the pedestrian to determine the pedestrian danger level:
a longitudinal distance between the route and the pedestrian, and
a lateral distance between the route and the pedestrian.

9. The vehicle of claim 1, wherein the at least one instruction is configured, when executed by the one or more processors communicating with the memory, to cause the vehicle to execute a fifth process configured to determine, based on the pedestrian danger level, a response control strategy for the vehicle, wherein the response control strategy comprises at least one of a stop response control or a deceleration response control.

10. The vehicle of claim 9, wherein the fourth process is configured to control the autonomous driving operation of the vehicle by:
determining a reliability value associated with the pedestrian based on whether a previous response control strategy for the pedestrian is output; and
determining, based on the pedestrian danger level and the reliability value associated with the pedestrian, whether a response control of the vehicle is needed.

11. The vehicle of claim 10, wherein the fourth process is configured to determine, based on the pedestrian information, whether a second pedestrian is present along a route of the vehicle and a predicted path of the pedestrian; and
determine, based on whether the second pedestrian is present, whether a response control of the vehicle is needed.

12. A method performed by an apparatus of a vehicle, the method comprising:
determining, based on map information and traffic signal information, intersection information regarding an intersection associated with the vehicle;
receiving, from one or more sensors of the vehicle, pedestrian information regarding a pedestrian present in an exterior environment of the vehicle;
determining, based on the pedestrian information indicating a position of the pedestrian, a pedestrian type of the pedestrian;
determining, based on the pedestrian type of the pedestrian and further based on vehicle movement information of the vehicle, a pedestrian danger level; and
controlling, based on the pedestrian danger level, an autonomous driving operation of the vehicle.

13. The method of claim 12, wherein the determining of the intersection information comprises:
determining, based on the map information, the intersection; and
determining, based on the vehicle movement information, a remaining distance and a remaining time to a stop line associated with a crosswalk in the intersection.

14. The method of claim 12, further comprising:
determining, based on a route of the vehicle passes through the intersection having a traffic light, a current state and a state change time of the traffic light.

15. The method of claim 12, wherein the determining of the pedestrian type comprises determining the pedestrian type based on an attribute of an area in which the pedestrian is positioned.

16. The method of claim 12, wherein the determining of the pedestrian danger level comprises:
determining, based on the pedestrian type, a predicted path of the pedestrian; and
determining, based on the vehicle movement information, a likelihood value of convergence of the predicted path of the pedestrian and a route of the vehicle.

17. The method of claim 16, wherein the determining of the pedestrian danger level further comprises:
determining, based on the likelihood value of the convergence being above a threshold and using the vehicle movement information and the predicted path of the pedestrian to determine the pedestrian danger level, a predicted location of the convergence, a predicted time of the convergence, a longitudinal distance between the route and the pedestrian, and a lateral distance between the route and the pedestrian; and
determining the pedestrian danger level based on the predicted location of the convergence, the predicted time of the convergence, the longitudinal distance and the lateral distance.

18. The method of claim 16, wherein the determining of the pedestrian danger level further comprises:
determining, based on the likelihood value of the convergence being below a threshold and using the vehicle movement information and the predicted path of the pedestrian to determine the pedestrian danger level:
a longitudinal distance between the route and the pedestrian, and
a lateral distance between the route and the pedestrian; and
determining the pedestrian danger level based on the longitudinal distance and the lateral distance.

19. The method of claim 12, further comprising:
determining, based on the pedestrian danger level, a response control strategy for the vehicle, wherein the response control strategy comprises at least one of a stop response control or a deceleration response control.

20. The method of claim 19, wherein the controlling of the autonomous driving operation of the vehicle comprises:
determining a reliability value associated with the pedestrian based on whether a previous response control strategy for the pedestrian is output;
determining whether a second pedestrian is present along a route of the vehicle and a predicted path of the pedestrian; and
determining, based on whether the second pedestrian is present and based on the reliability value, whether a response control of the vehicle is needed.
